(19) United States
(12) Patent Application Publication
(10) Pub. No.: US 2004/0033075 A1
(43) Pub. Date: Feb. 19, 2004

(54) Delivering multicast streams in a passive optical network

(76) Inventors: Christopher D. Koch, Minneapolis, MN (US); Duane M. Butler, Anoka, MN (US); Steven G. Knight, Saint Paul, MN (US); Milton J. Johnson, Lakeville, MN (US)

Correspondence Address: SHUMAKER & SIEFFERT, P. A., 8425 SEASONS PARKWAY, SUITE 105, ST. PAUL, MN, 55125, US

(21) Appl. No.: 10/449,865

(22) Filed: May 30, 2003

Related U.S. Application Data
(60) Provisional application No. 60/385,174, filed on May 31, 2002.

(51) Int. Cl. H04B 10/20

(52) U.S. Cl. 398/58

(57) ABSTRACT

An interface module of a Passive Optical Network (PON) maintains information associating Class-D Internet Protocol (IP) addresses for multicast streams with Asynchronous Transfer Mode (ATM) Virtual Circuit Channels (VCCs), and with nodes of the PON that have requested the multicast streams. When an interface module receives a first request for a multicast stream, it will associate a VCC and the requesting node with a Class-D IP address of the stream and deliver the stream on the associated VCC. The interface module may periodically deliver map packets to nodes to indicate the current Class-D IP to VCC mappings, and subsequent requesting nodes may obtain the stream by referring to the map packet. The interface module deletes the association of a node with a stream when it receives a disassociation request from the node, and delivers the stream on the associated VCC so long as any node is associated with the stream.

This application claims priority from U.S. provisional application serial No. 60/385,174, filed May 31, 2002, the entire content of which is incorporated herein by reference.

### TECHNICAL FIELD

The invention relates to computer networking and, more particularly, to the delivery of multicast streams within a passive optical network (PON).

### BACKGROUND

A passive optical network (PON) can deliver voice, video and other data among multiple network nodes using a common optical fiber link. Passive optical splitters and combiners enable a number of network nodes to share the optical fiber link. Each network node terminates the optical fiber link for a residential or business subscriber, and is sometimes referred to as a subscriber premises node. Each network node is connected to one or more subscriber devices, which ultimately receive the voice, video and other data delivered via the PON.

A PON typically includes a PON interface having multiple, independent PON interface modules that serve multiple optical fiber links. A PON interface module provides an interface for transmission and reception of data packets over a particular optical fiber link that serves a group of network nodes. A PON may be described as an inherently downstream-multicast medium, in that each packet placed on a fiber link by a PON interface module can be received by every network node served by that fiber link. Nodes identify selected packets on the fiber link to forward to connected subscriber devices, or otherwise process, based on addressing information included within the packets. Packet transmission between interface modules and nodes may be via Asynchronous Transfer Mode (ATM) Virtual Circuit Channels (VCCs) over the optical fiber links.

### SUMMARY

In general, the invention is directed to techniques for multicasting over a Passive Optical Network (PON). The multicasting techniques may be responsive to subscriber demand. In particular, the invention provides a requesting scheme to control when a downstream-multicast controller of an interface module on a PON initiates and stops delivery of a multicast stream on a fiber link that couples the interface module to a plurality of nodes on the PON. Employing such a requesting scheme, a downstream-multicast controller according to the invention only places a multicast stream on the fiber optic link if one or more connected nodes currently require the stream. The downstream-multicast controller may also dynamically map Class-D Internet Protocol (IP) addresses of multicast streams to Asynchronous Transfer Mode (ATM) Virtual Circuit Channels (VCCs) for delivery of the multicast streams via the associated VCCs.

When the downstream-multicast controller of an interface module receives a first request for a multicast stream, it will associate a VCC and the requesting node with a ClassD IP address of the stream, and deliver the stream on the associated VCC. The downstream-multicast controller may periodically deliver map packets to nodes to indicate the current Class-D IP to VCC mappings, and subsequent requesting nodes may identify the VCC on which the stream is being delivered by referring to the map packet. Alternatively, nodes may monitor messages sent by the downstream-multicast controller to other nodes on the optical fiber link in response to requests for multicast streams made by the other nodes. The messages indicate the association of the Class-D IP addresses of requested multicast streams with VCCs, and, when a node receives a request for a stream, the node may identify the VCC on which the stream resides based on information gathered from the messages.

When a node no longer requires the multicast stream, the node sends a disassociation request to the downstream-multicast controller. The downstream-multicast controller deletes the association of a node with a stream when it receives the disassociation request from the node. The downstream-multicast controller delivers the stream on the associated VCC so long as a connected node is associated with the stream. In other words, the downstream-multicast controller only places the stream on the optical fiber link if at least one connected node currently requires the stream.

In one embodiment, the invention is directed to a method that may be employed by a downstream-multicast controller of an interface module on a PON to deliver multicast streams on the PON. According to the method, a request for a multicast stream is received from a node of a PON via an optical fiber link. The multicast stream is identified by an IP address. Whether the multicast stream is currently being delivered on the optical fiber link is determined, and the IP address is associated with a VCC of the optical fiber link as a function of the determination. The multicast stream is delivered via the associated VCC. A map packet may be generated to indicate associations of IP address with VCCs, and the map packet may be delivered to each of a plurality of nodes on the PON.

In another embodiment, the invention is directed to an interface module of a PON that is connected to a plurality of nodes via a fiber optic link. The interface module comprises a downstream-multicast controller that receives a request for a multicast stream from one of the nodes. The multicast stream is identified by an IP address. The downstream-multicast controller determines whether the multicast stream is currently being delivered on the optical fiber link, associates the IP address with a VCC of the optical fiber link as a function of the determination, and delivers the multicast stream via the associated VCC. The downstream-multicast controller may generate a map packet to indicate associations of IP addresses with VCCs, and periodically deliver the map packet to each of the plurality of nodes.

In another embodiment, the invention provides a computer-readable medium containing instructions. The instructions cause a programmable processor to receive a request for a multicast stream from a node of a passive optical network via an optical fiber link. The multicast stream is identified by an IP address. The instructions further cause a programmable processor to determine whether the multicast stream is currently being delivered on the optical fiber link, associate the IP address with a VCC of the optical fiber link as a function of the determination, and deliver the multicast stream via the associated vcc.

In another embodiment, the invention is directed to a method that may be employed by a node of a PON to receive multicast streams on the PON. According to the method, a request for a multicast stream is received from a device. The multicast stream is identified by an IP address. Prior to receiving the request, a message is received from an interface module of a PON via an optical fiber link. A VCC of the optical fiber link carrying the multicast stream is identified based on the message, and packets of the multicast stream a received via the VCC. The message may indicated an association of the IP address with the VCC, and may be a map packet sent to each of a plurality of nodes that are coupled to the interface module via the optical fiber link.

In another embodiment, the invention is directed to a node of a PON, the PON including a plurality of nodes connected to an interface module by an optical fiber link. The node comprises a control unit that receives a request for a multicast stream from a device, the multicast stream identified by an IP address. Prior to receiving the request, the control unit receives a message from the interface module via the optical fiber link, identifies a VCC of the optical fiber link carrying the multicast stream based on the message, and receives packets of the multicast stream via the VCC. The message may indicate an association of the IP address with the VCC. The control unit may receive the message by receiving a map packet sent to each of a plurality of nodes that are coupled to the interface module by the optical fiber link.

In another embodiment, the invention provides a computer-readable medium containing instructions. The instructions cause a programmable processor to receive a request for a multicast stream from a device, the multicast stream identified by an IP address. Prior to receiving the request, the instructions cause a programmable processor to receive a message from an interface module of a PON via an optical fiber link. The instructions further cause a programmable processor to identify a VCC of the optical fiber link carrying the multicast stream based on the message, and receive packets of the multicast stream via the VCC. The message may indicate an association of the IP address with the VCC. The instructions that cause a programmable processor to receive a message may comprise instructions that cause a programmable processor to receive a map packet sent to each of a plurality of nodes that are coupled to the interface module via the optical fiber link.

In another embodiment, the invention is directed to a PON that includes a plurality of nodes, an interface module to receive a multicast stream from a multicast source, the multicast stream identified by an IP address, and an optical fiber link to connect the interface module to the nodes. The interface module receives a request for the multicast stream from one of the nodes, determines whether the multicast stream is currently being delivered on the optical fiber link, associates the IP address with a VCC of the optical fiber link as a function of the determination, and delivers the multicast stream on the associated VCC. The interface module may generate a map packet to indicate the associations of IP addresses with VCCs, and may periodically deliver the map packet to the plurality of nodes. The nodes may receive requests for multicast streams, and may identify VCCs that carry the requested multicast streams based on the map packet.

The invention may provide one or more advantages. For example, the requesting scheme of the invention may allow conservation of bandwidth on the fiber link. In particular, an interface module according to the invention may avoid streaming multicast packets down the PON when none of the subscribers on the PON have requested participation in a particular multicast. With bandwidth conservation, the Quality-of-Service (QoS) capabilities of the PON may be enhanced.

The Class-D address space used to identify multicast streams is larger than the available VCC address space. Dynamic association of multicast streams with VCCs may allow delivery of multicasts with addresses across the entire Class-D IP address space. Further, a method of distributing Class-D IP to VCC associations to nodes consistent with the invention may allow faster acquisition of the multicast stream by nodes when the stream is already being delivered on the fiber link. Instead of obtaining multicast details from interaction with a PON interface module, a node can quickly ascertain the VCC or other necessary information from the map packet that is sent periodically over the PON, or by monitoring control packets sent to other nodes on the PON. In this manner, the invention can accelerate multicast acquisition and reduce the perception of system latency from the perspective of the subscriber.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an exemplary PON.

FIG. 2 is a block diagram illustrating an exemplary PON connected to a multicast source.

FIG. 3 is a block diagram illustrating an exemplary PON interface module connected to an exemplary group of nodes.

FIG. 4 is a flowchart illustrating an exemplary method that may be employed by a PON interface module to deliver a multicast stream on a PON.

FIG. 5 is a flowchart illustrating an exemplary method that may be employed by a node to receive a multicast stream on a PON.

### DETAILED DESCRIPTION

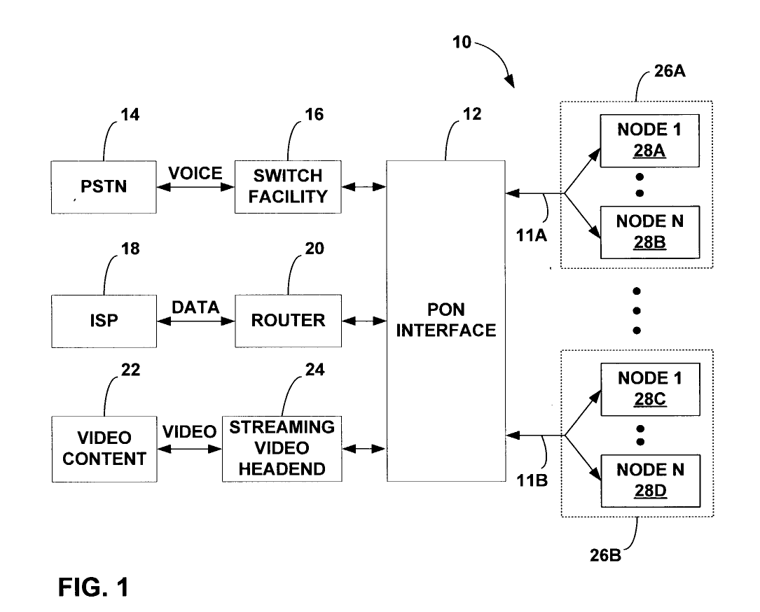

FIG. 1 is a block diagram illustrating a passive optical network (PON) 10. As shown in FIG. 1, PON 10 can be arranged to deliver voice, data and video content (generally “information”) to a number of network nodes via optical fiber links. Exemplary components for implementing a PON are commercially available from Optical Solutions, Inc., of Minneapolis, Minn., and designated by the tradename Fiberpath 400™, including the Fiberdrive™ headend bay interface and the Fiberpoint™ subscriber premise nodes.

A PON interface 12 may receive voice information, for example, from the public switched telephone network (PSTN) 14 via a switch facility 16. In addition, PON interface 12 may be coupled to one or more Internet service providers (ISP's) 18 via the Internet and a router 20. As further shown in FIG. 1, PON interface 12 may receive video content 22 from video content suppliers via a streaming video headend 24. In each case, PON interface 12 receives the information, and distributes it along optical fiber links 11A and 11B (collectively “fiber links 11”) to groups 26A and 26B (collectively “groups 26”) of network nodes 28A, 28B, 28C and 28D (collectively “nodes 28”). Each of groups 26 is coupled to a respective one of optical fiber links 11. PON interface 12 may be coupled to any number of fiber links 11. Accordingly, FIG. 1 shows only two fiber links 11A, 11B for purposes of illustration.

Network nodes 28 include hardware for receiving information from PON 10 via optical fiber links 11, and delivering the information to a connected device, or one or more connected devices within a local area network (LAN) associated with the node. For example, each network node 28 may serve as a PON access point for one or more computers, network appliances, televisions, set-top boxes, wireless devices, or the like. PON interface 12 may be located near or far from a group 26 of network nodes 28. In some existing networks, however, PON interface 12 may reside in a central office situated within approximately ten miles from each network node 28.

A network node 28 may be located at any of a variety of locations, including residential or business sites. In addition, a single network node 28 may operate on a shared basis to deliver information to two or more closely located residences or businesses via copper or additional optical fiber connections, either directly or via a network hub, router or switch. A group 26 of network nodes 28 may refer to nodes served by PON interface 12 via a common optical fiber link 11. Each group 26 in FIG. 1 contains two network nodes 28 for purposes of illustration. However, a group 26 may include a single network node, or numerous network nodes 28.

Network nodes 28 also may include hardware for transmitting information over PON 10. For example, a network node 28 may transmit voice information over PSTN 14 via PON interface 12 and switch facility 16 in the course of a telephone conversation. In addition, a network node 28 may transmit data to a variety of network nodes on the Internet via ISP 18, router 20 and PON interface 12. Multiple network nodes 28 typically transmit upstream over a common optical fiber link 11 using time division multiplexing techniques.

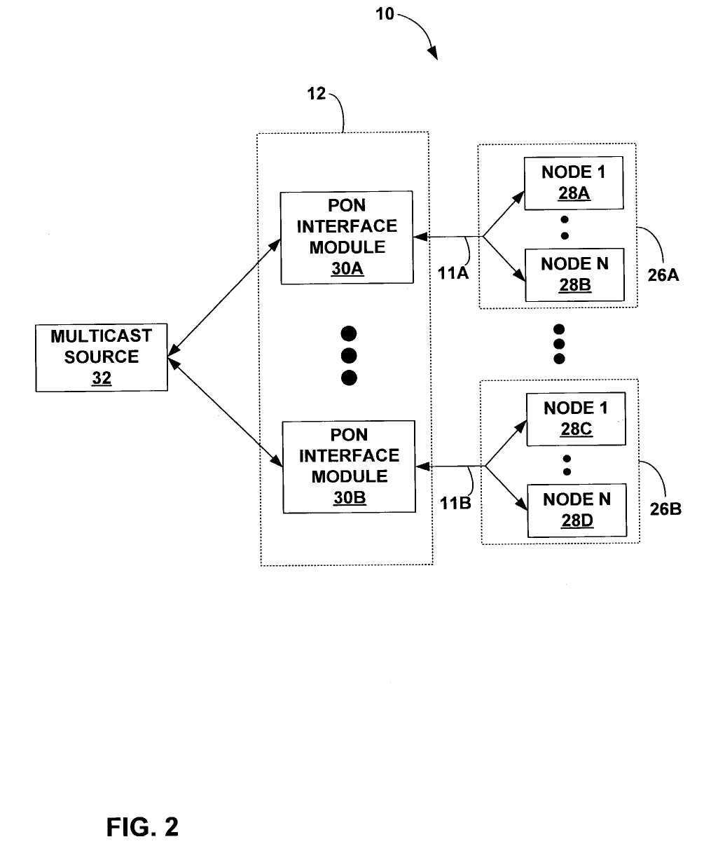

FIG. 2 is a block diagram illustrating an exemplary PON 10 connected to a multicast source 32. As shown in FIG. 2, groups 26 of network nodes 28 within PON 10 may be coupled to multiple PON interface modules 30A, 30B, 30C (collectively “interface modules 30”) within PON interface 12. PON interface 12 may include multiple PON interface modules 30, which may be arranged in a common chassis. Each PON interface module 30 may form an independent Ethernet interface that serves a group 26 of nodes 28 coupled to a common optical fiber link 11. Hence, a PON interface module 30 and associated nodes 28 terminate opposite ends of an optical fiber link 11. In some embodiments, an optical fiber link 11 may include a pair of optical fibers, forming an outgoing link and an incoming link.

As shown in FIG. 2, PON interface modules 30 may receive a multicast stream from multicast source 32. PON interface modules 30 deliver the stream to nodes 28 via optical fiber links 11 as will be described in greater detail below. Nodes 28 may then deliver the stream to one or more connected devices. PON interface modules 30 may deliver the stream as a function of packets received from nodes 28, as will also be described in greater detail below.

Multicast source 32 may, for example, be a remote server connected to interface modules 30 via routers within a network such as the Internet. Multicast source 32 may also be a streaming video headend 24 connected to interface modules 30 via a digital television network. A multicast stream may include real-time video, audio, voice and/or other types of data. A multicast stream may, for example, be a pay-per-view television event, a real-time audio broadcast, or real-time information provided via the Internet such as stock prices or weather conditions. In general, a multicast stream is received by an interface module 30 as multiple Internet Protocol (IP) multicast packets identified by a Class-D IP address within a destination address portion of the packet header. In some embodiments, interface 12, or interface modules 30, may assemble the IP multicast packets into ATM cells for multicast transmission on a VCC over links 11.

PON 10 may be described as an inherently downstream-multicast medium. In general, all nodes 28 associated with an interface module 30 may receive all downstream packet traffic to all other nodes 28 connected by a common optical fiber link 11 to the same interface module 30. This property of PON 10 allows an interface module 30 to deliver a multicast stream to all nodes 28 connected to the interface module 30 by a common optical fiber link 11 without replicating the packets of the multicast stream. Each node 28 is responsible for selecting packets, or cells, associated with a desired multicast stream.

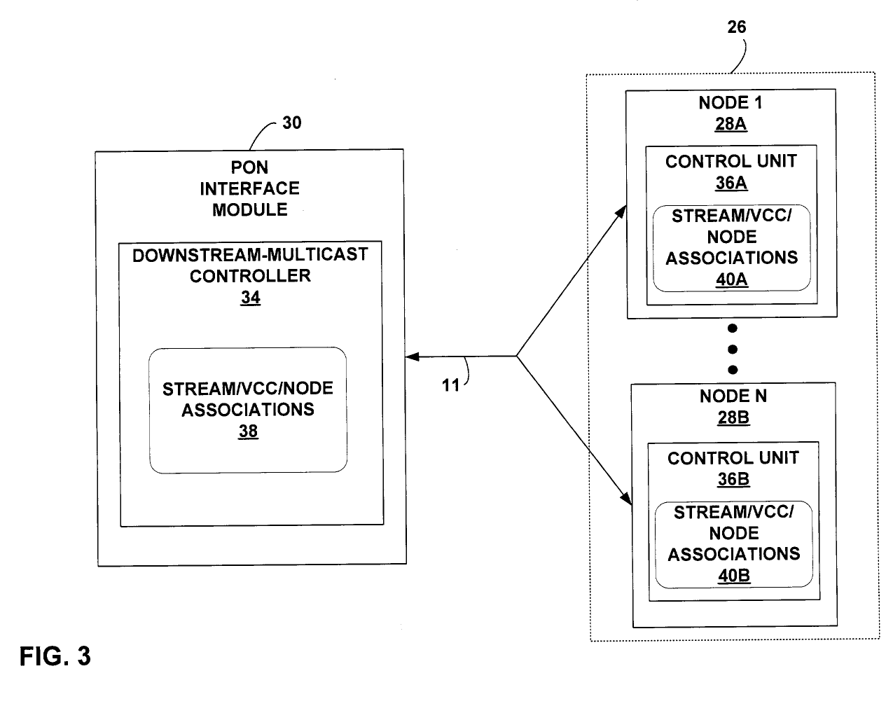

FIG. 3 is a block diagram illustrating an exemplary PON interface module 30 coupled to an exemplary group 26 of nodes 28 by a fiber link 11. In the exemplary embodiment of FIG. 3, interface module 30 includes a downstream-multicast controller 34. Downstream-multicast controller 34 controls the delivery of multicast streams via fiber link 11.

As will be described in greater detail below, downstream-multicast controller 34 and control units 36A and 36B (collectively “control units 36”) of nodes 28A and 28B, respectively, implement a requesting scheme to govern when downstream-multicast controller 34 initiates and stops delivery of a multicast stream on fiber link 11. It is desirable that downstream-multicast controller 34 not present the multicast stream on fiber link 11 until at least one of nodes 28 requests it, in order to conserve link bandwidth. In the absence of a requesting scheme, the multicast stream would indiscriminately be sent without regard to whether a request for the multicast stream has actually been made by a subscriber associated with a node 28. Bandwidth on fiber link 11 would potentially be wasted in the case that no nodes 28 are consuming the multicast stream. Further, because of the reduced bandwidth available on fiber link 11, quality of service, might not be able to be enforced.

As mentioned above, multicast streams are generally IP multicast in nature. Each stream has a unique Class-D IP address associated with it. Thus, control units 36 and downstream-multicast controller 34 may identify a multicast stream by its Class-D IP address.

Communication between control units 36 and downstream-multicast controller 34 may be via an asynchronous transfer mode (ATM) protocol. Accordingly, fiber link 11 may be logically divided into a number of virtual circuit channels (VCCs). Each VCC is defined by a virtual path identifier/virtual circuit identifier (VPI/VCI) pair within the ATM protocol header of an ATM cell delivered on fiber link 1.

Downstream-multicast controller 34 associates Class-D IP addresses with VCCs, and places multicast streams bearing a Class-D IP address on an associated VCC for delivery to nodes 28 via optical fiber 11. For ATM cells transmitted within PON 10, the VPI is generally twelve bits in length, and has a value associated with an interface module 30. The VCI is generally sixteen bits in length, and is addressable to create the VCCs on optical fiber 11. The Class-D IP address space is from 224.0.0.0 to 240.0.0.0, which corresponds to a twenty-eight bit address size.

The Class-D IP address space is greater than the VCI address space, i.e., there are more potentially available multicast streams than VCCs on which to put them. If downstream-multicast controller 34 statically associated Class-D IP addresses with VCCs, nodes 28 would not be able to receive all multicast streams. Consequently, downstream-multicast controller 34 dynamically associates Class-D IP addresses with VCCs.

In general, a PON 10 employing a requesting method and dynamic mapping consistent with the present invention may operate as follows. When a control unit 36 of a node 28 sends a request for a multicast stream not already being delivered on fiber link 11 to interface module 30, downstream-multicast controller 34 associates the Class-D IP address of the requested stream with a VCC, initiates flow of the multicast stream from multicast source 32, responds to the requesting node 28 with the VCC on which the Class-D stream is present, and delivers the stream on the associated VCC subject to availability, capacity, and other rules required for orderly distribution on PON 10. The requesting node 28 can then start to acquire the stream via the associated VCC.

When the control unit 36 of another node 28 requests a stream that is currently being delivered on fiber link 11, downstream-multicast controller 34 responds with the associated VCC on which the multicast stream is carried. The Class-D IP address to VCC association may be stored in a memory, e.g., resident within downstream-multicast controller 34. In order to manage the bandwidth on fiber link 11 appropriately, when nodes 28 request a multicast stream, downstream-multicast controller 34 may associate the requesting nodes 28 with the stream. Downstream-multicast controller 34 may, for example, associate Class-D IP addresses with media access control (MAC) addresses that identify nodes 28. Downstream-multicast controller 34 may store Class-D IP/VCC/Node associations as one or more tables, databases, flat files, radix trees, or the like.

When a node 28 no longer requires a stream, the corresponding control unit 38 sends a disassociation request to downstream-multicast controller 34 to delete the association of the requesting node 28 with the stream. If all nodes 28 connected to interface module 30 by fiber link 11 no longer have an association with a multicast stream that is being delivered, downstream-multicast controller 34 stops delivery of the multicast stream on fiber link 11, and releases the dynamic association of the Class-D IP address with a VCC.

In response to the message requesting a multicast stream from a node 28, downstream-multicast controller 34 sends a reply identifying the VCC on which the stream may be received. With the requested stream on optical fiber 10, it would be desirable for subsequent requesting nodes 28 to identify the correct VCC carrying the requested stream without waiting for a reply from downstream-multicast controller 34. Subsequent requesting nodes 28 may identify the correct VCC without waiting for a replay from downstream-multicast controller 34 in a number of ways.

For example, as described above, downstream-multicast controller 34 may maintain a table 38 mapping the current Class-D IP to VCC associations in a memory. Downstream-multicast controller 34 may periodically send a broadcast map packet to all nodes 28 connected by fiber link 11 that indicates the current status of the Class-D IP to VCC mappings. Delivery of this broadcast map packet, as well as requested packets from nodes 28 and other control packets exchanged by nodes 28 and downstream-multicast controller 34A may occur via one or more designated control VCCs.

Control units 36A and 36B of nodes 28A and 28B may parse the broadcast map packets as received, and may maintain tables 40A and 40B of the current mappings in a memory, or may parse a stored most recent broadcast packet when a request for a stream is received from a connected device. Thus, when a node 28 receives a request from a connected device for a multicast stream, the node 28 may refer to the current mappings, determine if the stream is currently being delivered, and, if so, acquire the stream on the associated VCC without waiting for a response from downstream-multicast controller 34. This approach may significantly accelerate multicast acquisition time for a given node 28.

The broadcast map packet is a temporary time-relative mapping, meaning that it is relative to the current state of the map when downstream-multicast controller 34 created the map packet. Between the time that the message is received by a node 28, and the potential use of the map by the node 28, downstream-multicast controller 34 could have changed the current map. Synchronization methods for keeping the maps current to all parties are possible, but are time consuming.

As an alternative to sending broadcast map packets, each node may monitor the Class-D IP to VCC association responses sent to other nodes 28 by downstream-multicast controller 34 on a control VCC specified for such messages. Thus, each node 28 may independently maintain a table 40 that maps Class-D IP to VCC associations. Each node 28 may also keep track of request for streams and disassociation requests to maintain node to Class-D IP address associations as described above with respect to downstream-multicast controller 34. This may be done to determine whether downstream-multicast controller 34 has stopped delivering the stream and deleted the Class-D IP to VCC association.

In both methods described above, a node 28 can acquire the multicast stream on the associated VCC without receiving a response from downstream-multicast controller 34. Node 28 may also be able to determine whether the mapping is outdated. In the event that the map is “outdated,” meaning that downstream-multicast controller 34 has dissolved the Class-D IP to VCC association, then the multicast stream Class-D IP address will not be the one the node 28 was expecting. In particular, node 28 will receive and unframe the ATM packet with the VCI/VPI address of the associated VCC to retrieve the IP multicast packet contained therein. If the Class-D IP address is not the Class-D IP address of the desired stream, the node 28 will discard it until it receives an acknowledgement or subsequent map packet from downstream-multicast controller 34 that indicates the correct VCC.

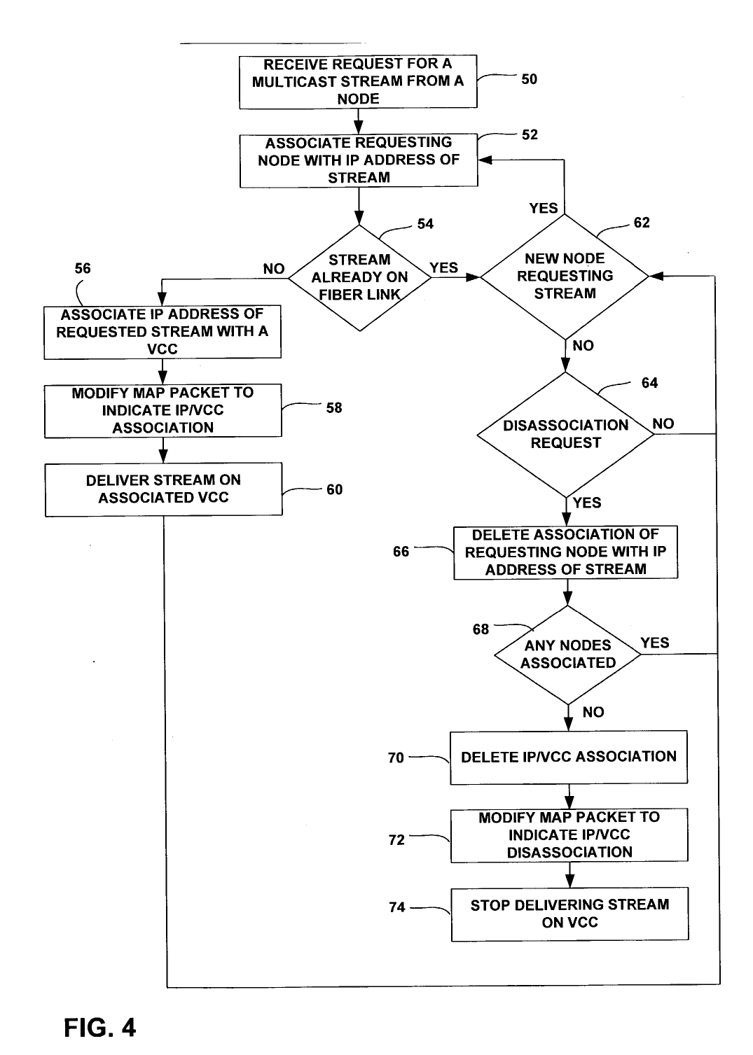

FIG. 4 is a flowchart illustrating an exemplary method of delivering a multicast stream on PON 10. When a downstream-multicast controller 34 of an interface module receives a request for a multicast stream from a linked node 28 (50), downstream-multicast controller 34 may associate the requesting node 28 with the Class-D IP address of the stream as described above (52). Downstream-multicast controller 34 may then determine if the requested stream is already on fiber link 11 (54). Downstream-multicast controller 34 may make this determination with reference to a table 36 mapping Class-D IP addresses to VCCs.

If the stream is not currently being delivered on the fiber link 11, i.e., if requesting node 28 is the first node to request the stream, downstream-multicast controller 34 will associate the Class-D IP address of the stream with a VCC as described above (56). Downstream-multicast controller may also update a table 36 that maps Class-D IP addresses to VCCs as described above, thus modifying a periodically delivered broadcast map packet, as described above, to indicate the new Class-D IP to VCC association (58). After associating the Class-D IP address to a VCC and retrieving the requested stream from a multicast source, downstream-multicast controller 34 may initiate delivery of the stream on the associated VCC (60).

While a particular stream is being delivered on fiber link 11, downstream-multicast controller 34 will wait for new nodes 28 to request the stream (62), or for nodes 28 to send disassociation requests that indicate that the stream is no longer needed by the requesting node (64). As new nodes 28 request the stream, downstream-multicast controller 34 will associate the new nodes 28 with the Class-D IP address of the stream as described above (62). When a disassociation request is received from a node 28 that previously requested a particular multicast, the downstream-multicast controller 34 will delete the association of the requesting node 28 with the stream (66).

So long as any node 28 is associated with the stream, downstream-multicast controller 34 will continue to deliver the stream on the associated VCC. If no nodes are associated with the stream, downstream-multicast controller 34 may delete the Class-D IP to VCC association (70), thus modifying the map packet to indicate the disassociation (72). Downstream-multicast controller 34 may also stop delivery of the stream on the associated VCC (74).

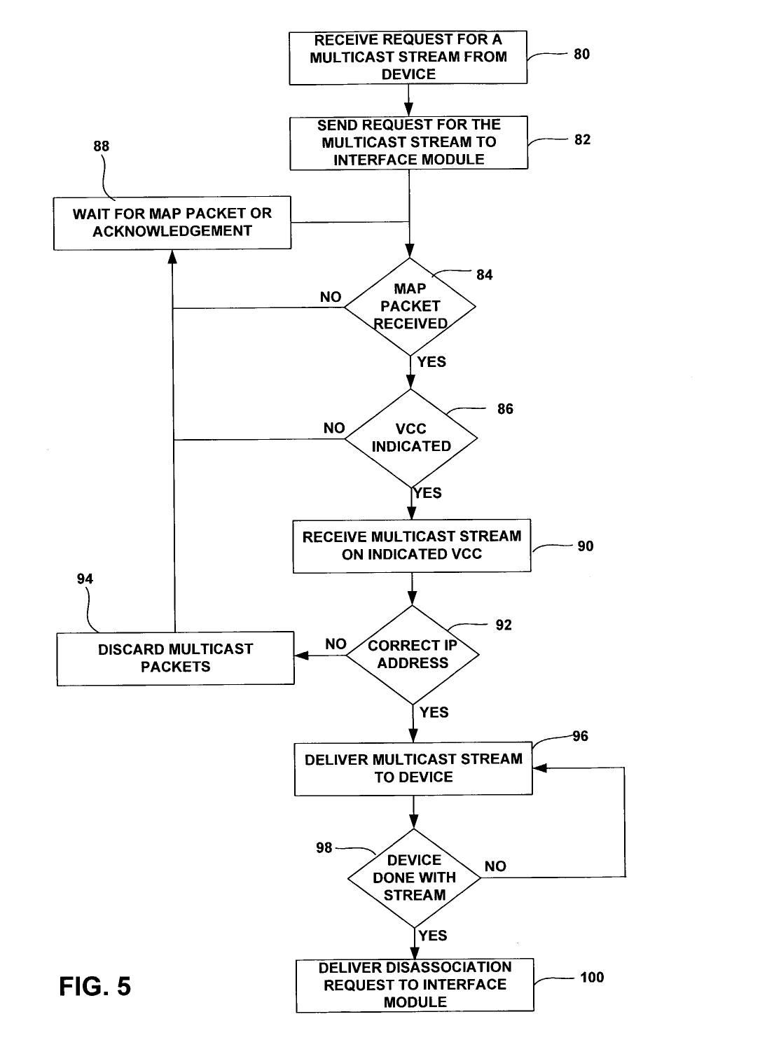

FIG. 5 is a flowchart illustrating an exemplary method of receiving a multicast stream on a PON. When a node 28 receives a request for a multicast stream from an attached device (80), such as a request from a set-top box for a pay-per-view event, node 28 will send a request for the multicast stream to interface module 30 via fiber link 11 (82). Node 28 may determine whether it had previously received a map packet that might indicate which VCC the stream is being delivered on from the interface module (84). If no map packet has been received, or if the received map packet does not indicate that the Class-D IP address of the stream is associated with a VCC (86), node 28 may wait for a new map packet or an acknowledgement from interface module 30 indicating which VCC the stream may be received on (88). If the previously received map packet indicates the VCC, node 28 may begin to receive the stream on the indicated VCC (90).

As described above, when node 28 receives packets on the indicated VCC, node 28 will unframe the ATM cells to retrieve the IP multicast packet contained therein. The node may then determine whether the Class-D IP address of the multicast packet is the Class-D IP address of the requested stream (92). If the Class-D IP address is not the Class-D IP address of the requested stream, the node 28 will discard it (94) and wait for an acknowledgement or subsequent map packet from downstream-multicast controller 34 that has the correct VCC contained in it (96). If the Class-D IP address of the packet is the correct address, node 28 will deliver the multicast stream to the requesting device (96) until node 28 receives an indication that the device is done with the stream (98). If node 28 receives an indication that the device is done with the stream, node 28 may deliver a disassociation request to interface module 30 as described above (100).

As described above, the present invention may provide a requesting scheme to control when downstream-multicast controller of an interface module on a PON initiates and stops delivering a multicast stream on a fiber link, dynamic mapping of Class-D IP addresses to ATM VCCs, and a method of distributing the Class-D IP to VCC associations to nodes over a multicast PON network topology. These features may be advantageous in that they allow conservation of bandwidth on the fiber link, utilization of the entire Class-D IP address space, and faster acquisition of the multicast stream by nodes when the stream is already being delivered on the fiber link.

Various embodiments of the invention have been described. Method embodiments, PON embodiments, PON interface module embodiments, and PON node embodiments have been described. However, one skilled in the art will appreciate that various modifications or additions may be made to the described embodiments without departing from the scope of the claimed invention.

Downstream-multicast controllers 34 and control units 36, as described herein may include one or more processors, e.g. one or more microprocessors, digital signal processors (DSPs), application specific integrated circuits (ASICs), field-programmable gate arrays (FPGAs), or other programmable logic circuitry. Downstream-multicast controllers 34 and control units 36 may execute program instructions stored within computer-readable media that cause downstream-multicast controllers 34 and control units 36 to perform the functions ascribed to them herein. Consequently, some embodiments take the form of a computer-readable medium comprising instructions that cause a programmable processor to perform the functions ascribed to a downstream-multicast controller 34 or control unit 36 herein. A computer-readable medium may be any electronic, magnetic, or optical medium, such as a random access memory (RAM), read-only memory (ROM), CD-ROM, hard or floppy magnetic disk, electronically erasable and programmable ROM (EEPROM), flash memory, or the like. These and other embodiments are within the scope of the following claims.

1. A method comprising:
receiving a request for a multicast stream from a node of a passive optical network via an optical fiber link, the multicast stream being identified by an Internet Protocol address;
determining whether the multicast stream is currently being delivered on the optical fiber link;
associating the Internet Protocol address with a virtual circuit channel of the optical fiber link as a function of the determination; and
delivering the multicast stream via the associated virtual circuit channel.

2. The method of claim 1, wherein a plurality of nodes is coupled to the optical fiber link, the method further comprising:
generating a map packet to indicate associations of Internet Protocol addresses with virtual circuit channels; and
delivering the map packet to each of the plurality of nodes on the passive optical network.

3. The method of claim 2, wherein delivering the map packet comprises delivering the map packet periodically.

4. The method of claim 2, wherein delivering the map packet comprises delivering the map packet via a control virtual circuit channel.

5. The method of claim 1, further comprising:
associating the node with the Internet Protocol address; and
storing an indication of the association of the node with the Internet Protocol address in a memory.

6. The method of claim 1, wherein a plurality of nodes is coupled to the optical fiber link, and
delivering the multicast stream comprises delivering the multicast stream via the associated virtual circuit channel so long as any of the plurality of nodes is associated with the Internet Protocol address.

7. An interface module of a passive optical network, the interface module connected to a plurality of nodes via a fiber optic link, the interface module comprising a downstream-multicast controller that receives a request for a multicast stream from one of the nodes, the multicast stream being identified by an Internet Protocol address,
wherein the downstream-multicast controller determines whether the multicast stream is currently being delivered on the optical fiber link, associates the Internet Protocol address with a virtual circuit channel of the optical fiber link as a function of the determination, and delivers the multicast stream via the associated virtual circuit channel.

8. The interface module of claim 7, wherein the downstream-multicast controller generates a map packet to indicate associations of Internet Protocol addresses with virtual circuit channels and periodically delivers the map packet to each of the plurality of nodes.

9. The interface module of claim 8, wherein the downstream-multicast controller delivers the map packet via a virtual circuit channel.

10. The interface module of claim 7, wherein the downstream-multicast controller associates the requesting one of the nodes with the Internet Protocol address, and stores an indication of the association of the requesting one of the nodes with the Internet Protocol address in a memory.

11. The interface module of claim 7, wherein the downstream-multicast controller delivers the multicast stream via the virtual circuit channel so long as any of the nodes is associated with the Internet Protocol address.

12. A computer-readable medium comprising instructions that cause a programmable processor to:
receive a request for a multicast stream from a node of a passive optical network via an optical fiber link, the multicast stream identified by an Internet Protocol address;
determine whether the multicast stream is currently being delivered on the optical fiber link;
associate the Internet Protocol address with a virtual circuit channel of the optical fiber link as a function of the determination; and
deliver the multicast stream via the associated virtual circuit channel.

13. The computer readable medium of claim 12, wherein a plurality of nodes is coupled to the optical fiber link, the medium further comprising instructions that cause a programmable processor to:
generate a map packet to indicate associations of Internet Protocol addresses with virtual circuit channels; and
periodically deliver the map packet to each of the plurality of nodes on the passive optical network.

14. The computer-readable medium of claim 12, further comprising instructions that cause a programmable processor to:
associate the node with the Internet Protocol address; and
store an indication of the association of the node with the Internet Protocol address in a memory.

15. The computer-readable medium of claim 14, wherein a plurality of nodes is coupled to the optical fiber link, and
the instructions that cause a programmable processor to deliver the multicast stream comprise instructions that cause a programmable processor to deliver the multicast stream via the associated virtual circuit channel so long as any of the plurality of nodes is associated with the Internet Protocol address.

16. A method comprising:
receiving a request for a multicast stream from a device, the multicast stream identified by an Internet Protocol address;
prior to receiving the request, receiving a message from an interface module of a passive optical network via an optical fiber link;
identifying a virtual circuit channel of the optical fiber link carrying the multicast stream based on the message; and
receiving packets of the multicast stream via the virtual circuit channel.

17. The method of claim 16, wherein the message indicates an association of the Internet Protocol address with the virtual circuit channel.

18. The method of claim 16, wherein receiving a message comprises receiving a map packet sent to each of a plurality of nodes that are coupled to the interface module via the optical fiber link.

19. The method of claim 16, further comprising sending a request for the multicast stream to the interface module,
wherein receiving a message comprises monitoring messages sent to nodes by the interface module in response to previous requests for the multicast stream.

20. The method of claim 16, wherein receiving the message comprises receiving the message via a control virtual circuit channel.

21. A node of a passive optical network that includes a plurality of nodes connected to an interface module by an optical fiber link, the node comprising a control unit that receives a request for a multicast stream from a device, the multicast stream identified by an Internet Protocol address,
wherein prior to receiving the request, the control unit receives a message from the interface module via the optical fiber link, and
wherein the control unit identifies a virtual circuit channel of the optical fiber link carrying the multicast stream based on the message, and receives packets of the multicast stream via the virtual circuit channel.

22. The node of claim 21, wherein the message indicates an association of the Internet Protocol address with the virtual circuit channel.

23. The node of claim 21, wherein the control unit receives the message by receiving a map packet sent to each of the plurality of nodes that are coupled to the interface module via the optical fiber link.

24. The node of claim 21, wherein the control unit sends a request for the multicast stream to the interface module, and receives a message by monitoring messages sent to others of the plurality of nodes by the interface module in response to previous requests for the multicast stream.

25. The node of claim 21, wherein the control unit receives the message via a control virtual circuit channel.

26. A computer-readable medium comprising instructions that cause a programmable processor to:
receive a request for a multicast stream from a device, the multicast stream identified by an Internet Protocol address;
prior to receiving the request, receive a message from an interface module of a passive optical network via an optical fiber link;
identify a virtual circuit channel of the optical fiber link carrying the multicast stream based on the message; and
receive packets of the multicast stream via the virtual circuit channel.

27. The computer-readable medium of claim 26, wherein the message indicates an association of the Internet Protocol address with the virtual circuit channel.

28. The computer-readable medium of claim 26, wherein the instructions that cause a programmable processor to receive a message comprise instructions that cause a programmable processor to receive a map packet sent to each of a plurality of nodes that are coupled to the interface module via the optical fiber link.

29. The computer-readable medium of claim 26, further comprising instructions that cause a programmable processor to send a request for the multicast stream to the interface module,
wherein the instructions that cause a programmable processor to receive a message comprise instructions that cause a programmable processor to monitor messages sent to nodes by the interface module in response to previous requests for the multicast stream.

30. A passive optical network comprising:
a plurality of nodes;
an interface module to receive a multicast stream from a multicast stream source, the multicast stream identified by an Internet Protocol address; and
an optical fiber link to connect the interface module to the nodes,
wherein the interface module receives a request for the multicast stream from one of the nodes, determines whether the multicast stream is currently being delivered on the optical fiber link, associates the Internet Protocol address with a virtual circuit channel of the optical fiber link as a function of the determination, and delivers the multicast stream on the associated virtual circuit channel.

31. The passive optical network of claim 30, wherein the interface module generates a map packet to indicate associations of Internet Protocol addresses with virtual circuit channels, and periodically delivers the map packet to the plurality of nodes, and
wherein the nodes receive requests for multicast streams, and identify virtual circuit channels that carry the requested multicast streams based on the map packet.

32. The passive optical network of claim 30, wherein the interface module associates the requesting one of the nodes with the Internet Protocol address, and stores an indication of the association of the requesting one of the nodes with the Internet Protocol address in a memory.

33. The passive optical network of claim 32, wherein the interface module delivers the multicast stream via the virtual circuit channel so long as any node is associated with the Internet Protocol address.
